(19) United States
(12) Patent Application Publication
(10) Pub. No.: US 2006/0234562 A1
(43) Pub. Date: Oct. 19, 2006

(54) Socket connector for coaxial plug

(76) Inventor: Tung Chang Lin, Wu Ku Hsiang (TW)

Correspondence Address: MOLEX INCORPORATED, 2222 WELLINGTON COURT, LISLE, IL, 60532, US

(21) Appl. No.: 11/390,888

(22) Filed: Mar. 28, 2006

(30) Foreign Application Priority Data
Apr. 6, 2005 (TW) 94205302

(51) Int. Cl. H01R 24/04

(52) U.S. Cl. 439/668

(57) ABSTRACT

A socket connector includes an insulative housing having a plug-insertion opening leading to an interior plug-receiving cavity. At least one signal terminal is mounted in the housing and includes a contact portion exposed in the cavity for engaging a signal section of the coaxial plug when inserted into the cavity. A ground terminal is mounted in the housing and includes a tubular portion interengaged with a terminal portion. The tubular portion is mounted coincident with the plug-insertion opening in the housing for receiving the coaxial plug therethrough. The terminal portion has a through hole aligned with the tubular portion, and a pair of resilient contact arms are provided at the through hole for engaging a ground section of the coaxial plug.

### FIELD OF THE INVENTION

This invention generally relates to the art of electrical connectors and, particularly, to a socket connector for receiving a coaxial plug such as an audio plug.

### BACKGROUND ART

FIGS. 1-5 show a conventional socket connector, generally designated 1, as can be found in the prior art. The socket connector is designed for receiving a conventional coaxial plug, generally designated 2, as is known in the art. The coaxial plug may be an audio plug, for instance. The coaxial plug includes an annular switch section 2a, a signal section 2b and a ground section 2c, the sections being insulatingly separated axially or longitudinally of the plug. Referring specifically to FIG. 1, socket connector 1 includes a dielectric or insulative housing, generally designated 3, a cover 4 for the housing, a connector tube 5 for mounting in the top of the housing, and a terminal array, generally designated 6, mounted in the housing, along with a ground terminal 7 also mounted in the housing.

Housing 3 is molded of plastic material and is designed for mounting on a printed circuit board. To that end, the housing has a pair of mounting posts 3a and a pair of latch arms 3b for insertion into appropriate holes in the circuit board. The housing has a back wall 3c, a pair of side walls 3d and a top wall 3e. The walls combine to form an interior plug-receiving cavity, generally designated 8. A plug-insertion opening 9 is formed in top wall 3e. A plurality of terminal-mounting grooves 10 are formed on the inside of back wall 3c of the housing.

Cover 4 is provided for closing the interior plug-receiving cavity as is shown in FIG. 3. The cover has a plurality of holes 4a for receiving a plurality of mounting posts 11 (FIG. 4) molded integrally with and projecting from housing 3.

Terminal array 6 includes a pair of signal terminals 12 and 13 and a pair of switch terminals 14 and 15. All of these terminals are mounted within respective ones of the terminal-mounting grooves 10 in the housing as is shown in FIG. 4. Signal terminals 12 and 13 have contact portions 12a and 13a, respectively, exposed within the plug-receiving cavity 8. All of the signal and switch terminals have tail portions for insertion into appropriate holes in the circuit board and for connection, as by soldering, to appropriate circuit traces on the board and/or in the holes.

Connector tube 5 is mounted within the plug-insertion opening 9 of the housing, as can be seen in FIG. 4. The tube is fabricated of conductive metal material and includes an enlarged ring-like flange 5a for abutting against the top of top wall 3e of the housing.

Referring specifically to FIG. 2 in conjunction with FIG. 1, ground terminal 7 is generally L-shaped and includes a horizontal leg 7a and a vertical leg 7b. The vertical leg terminates in a pin portion 7c for insertion into an appropriate hole in the circuit board and for connection to an appropriate ground trace on the board. Horizontal leg 7a has a through hole 7d for insertion therethrough of coaxial plug 2. Ground terminal 7 and connector tube 5 are joined as a unitary structure by riveting the bottom distal end of the connector tube within through hole 7d of the ground terminal, as shown by riveting 16 in FIG. 2. When so joined, through hole 7d in the ground terminal is aligned with a through hole 17 (FIG. 4) in the connector tube.

When coaxial plug 2 is inserted through connector tube 5 into the interior plug-receiving cavity 8 of housing 3 as shown in FIG. 5, switch section 2a (FIG. 1) of the coaxial plug engages contact portion 12a of signal terminal 12, which, in turn, disengages switch terminal 14 from switch terminal 15 as indicated by arrow “A” (FIG. 5). Signal section 2b of the coaxial plug then engages the contact portions 12a and 13a of signal terminals 12 and 13, respectively, to establish a circuit through the signal terminals. The ground section 2c of the coaxial plug engages within connector tube 5 which, in turn, is conductively joined to ground terminal 7 and, thereby, the coaxial plug is grounded to the ground circuit on the printed circuit board.

One of the problems with prior art socket connector 10 involves the wear caused by repeated insertions and withdrawals of the coaxial plug into and out of the metal connector tube 5. Sideways forces created during normal insertions, along with skewed forces caused by sequential engagements with contact portions 12a and 13a of signal terminals 12 and 13, respectively, causes the inner wall surface of the connector tube to become scratched and worn over prolonged use. The through hole in the metal connector tube actually can become enlarged, resulting in bad connections between the coaxial plug and the connector tube and, in turn, bad connections with the ground circuit on the printed circuit board. Shaking of the coaxial plug within the connector tube actually can occur and this worsens over prolonged use, particularly when transverse external forces are applied to the coaxial plug. The resulting bad connections do not allow all of the surplus static electricity to be completely conducted to ground and noise will be generated to affect sound quality in various applications. The present invention is directed to solving these problems.

### SUMMARY OF THE INVENTION

An object, therefore, of the invention is to provide a new and improved socket connector for receiving a coaxial plug such as an audio plug.

In the exemplary embodiment of the invention, the socket connector includes an insulative housing having a plug-insertion opening leading to an interior plug-receiving cavity. At least one signal terminal is mounted on the housing and includes a contact portion exposed in the cavity for engaging a signal section of the coaxial plug when inserted into the cavity. A ground terminal is mounted on the housing and includes a tubular portion interengaged with a terminal portion. The tubular portion is mounted coincident with the plug-insertion opening in the housing for receiving the coaxial plug therethrough. The terminal portion has a through hole aligned with the tubular portion, and a pair of resilient contact arms are provided at the through hole for engaging a ground section of the coaxial plug.

According to one aspect of the invention, the contact arms include inwardly projecting contact bosses which provide positive contact points for engaging the ground section of the coaxial plug. Preferably, the contact arms are disposed on diametrically opposite sides of the through hole in the terminal portion of the ground terminal.

According to another aspect of the invention, the ground terminal is a two-part interengaging structure. The tubular portion and the terminal portion are separate from and independent of each other and are conductively joined.

According to a further aspect of the invention, the terminal portion of the ground terminal is generally L-shaped to define a mounting leg and a terminal leg extending at a right angle to the mounting leg. The mounting leg includes the through hole and is ring-shaped, with the contact arms located at an inner periphery of the ring. The terminal leg includes a terminal pin at a distal end thereof for insertion into an appropriate hole in the circuit board.

As disclosed herein, the housing includes an access opening remote from the plug-insertion opening for gaining access to the interior cavity to mount the terminals therewithin. The housing includes a cover for closing the access opening. The housing includes a terminal-positioning groove facing the access opening for receiving the terminal portion of the ground terminal.

Other objects, features and advantages of the invention will be apparent from the following detailed description taken in connection with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is an exploded elevational view of a socket connector of the prior art and as described in the Background, above;

FIG. 2 is a perspective view of the connector tube and ground terminal of the prior art connector;

FIG. 3 is a perspective view of the prior art connector in assembled condition;

FIG. 4 is a side elevational view of the prior art connector, with the cover removed and with a sectional depiction through the connector tube and the ground terminal;

FIG. 5 is a view similar to that of FIG. 4, with the coaxial plug inserted into the connector;

FIG. 6 is an exploded perspective view of a socket connector according to the invention herein;

FIG. 7 is a side elevational view of the housing of the connector herein, with the cover removed;

FIG. 8 is a side elevational view of the connector herein, with the cover removed and in conjunction with a coaxial plug shown in phantom;

FIG. 9 is a top plan view of the connector;

FIG. 10 is a vertical section taken generally along line 10-10 in FIG. 9;

FIG. 11 is a view identical to that of FIG. 9;

FIG. 12 is a vertical section taken generally along line 12-12 in FIG. 11;

FIG. 13 is a perspective view of the connector in fully assembled condition;

FIG. 14 is a view similar to that of FIG. 8, with the coaxial plug inserted into the connector; and

FIG. 15 is an enlarged vertical section through the connector, in a direction to show the contact arms on the ground terminal in engagement with the coaxial plug.

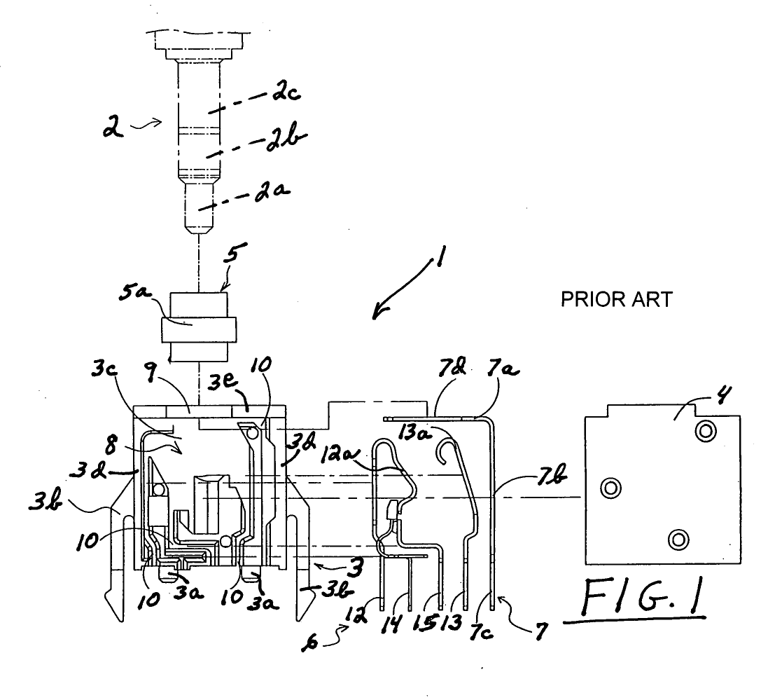

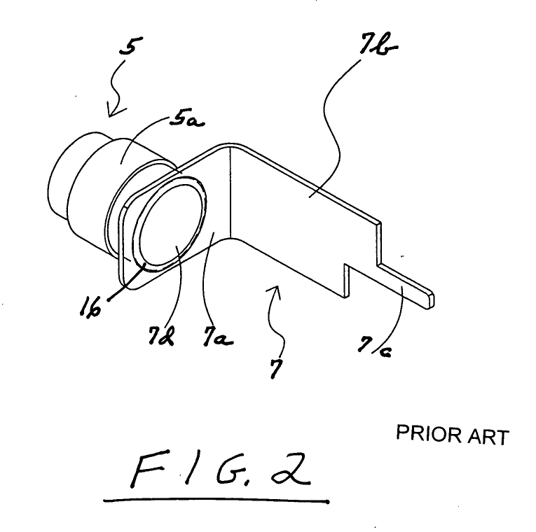

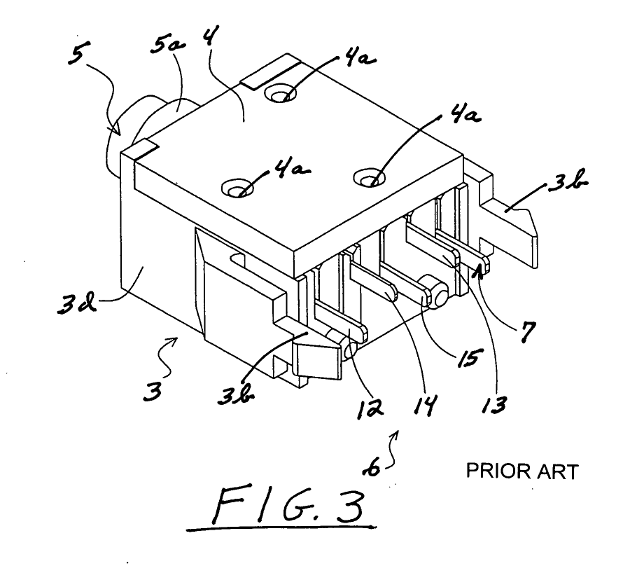

### DETAILED DESCRIPTION OF THE PREFERRED EMBODIMENT

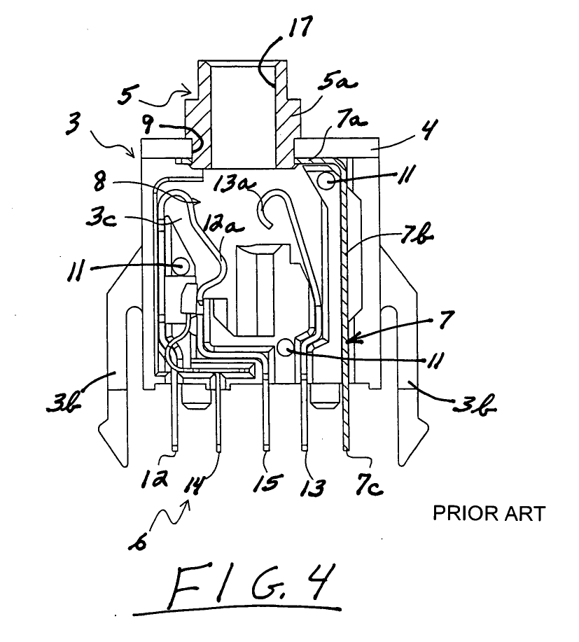

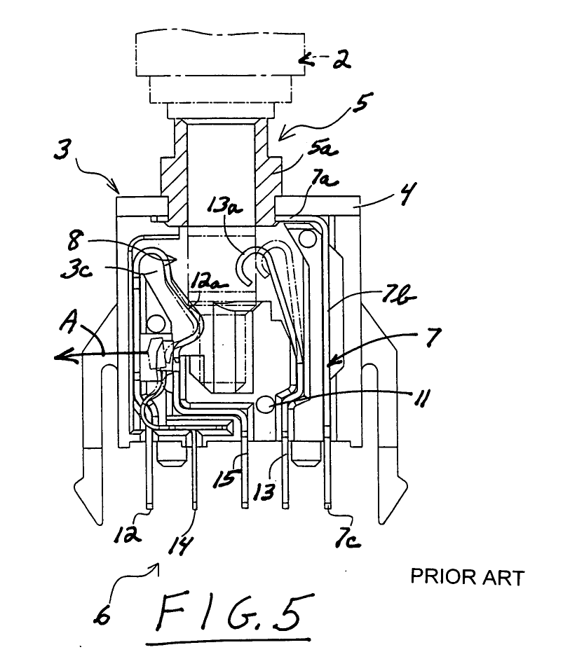

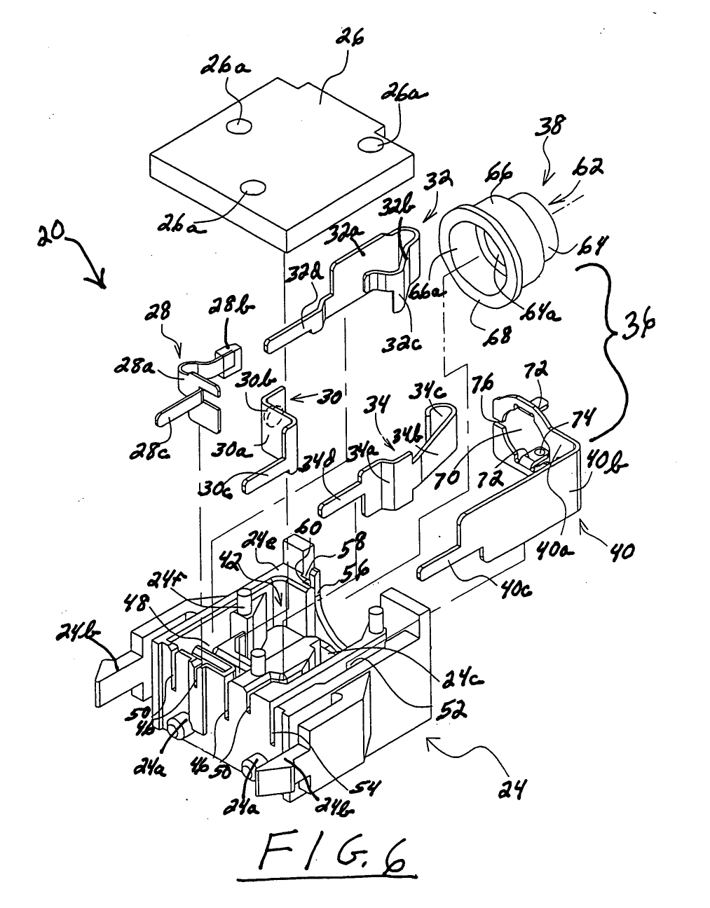

Referring to the drawings in greater detail, and first to FIG. 6, the invention is embodied in a socket connector, generally designated 20, for receiving a coaxial plug, generally designated 22 (FIG. 4) such as an audio plug. Generally, connector 20 includes an insulative housing, generally designated 24; a cover, generally designated 26, for closing the housing; a pair of switch terminals, generally designated 28 and 30, mounted within the housing; a pair of signal terminals, generally designated 32 and 34, mounted within the housing; and a ground terminal 36 which includes a tubular portion, generally designated 38, and a ground terminal portion, generally designated 40.

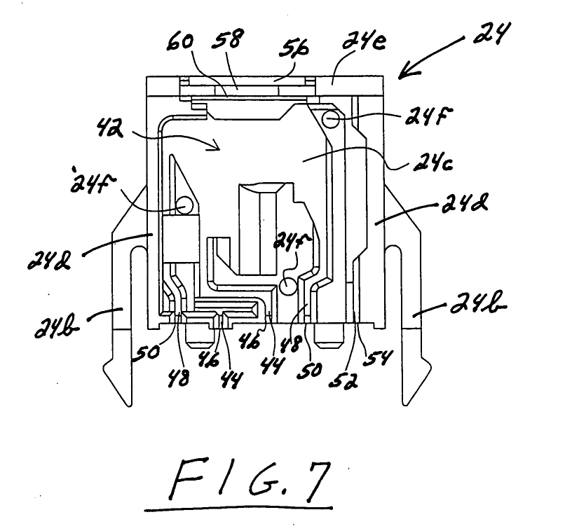

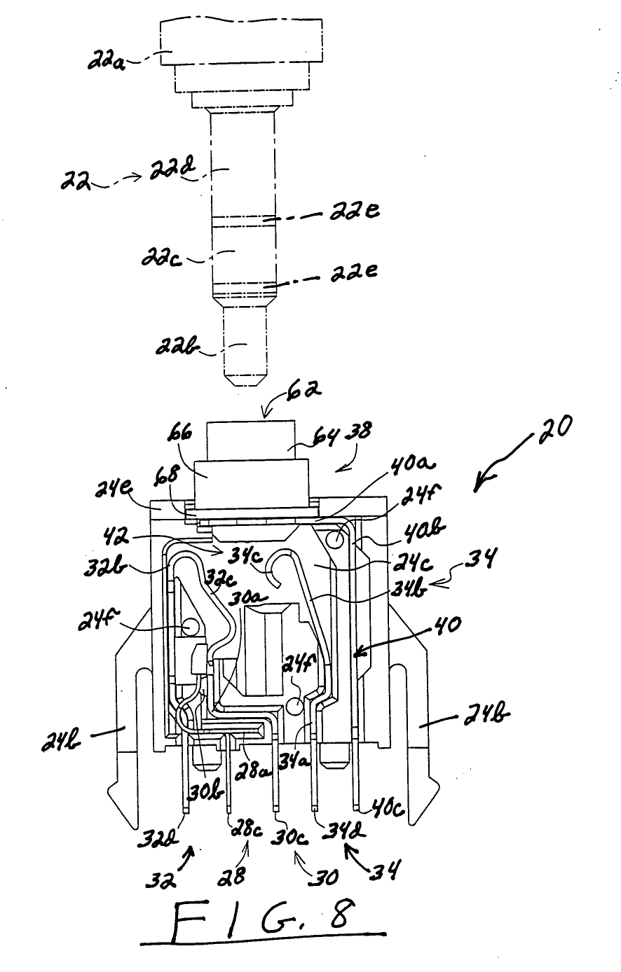

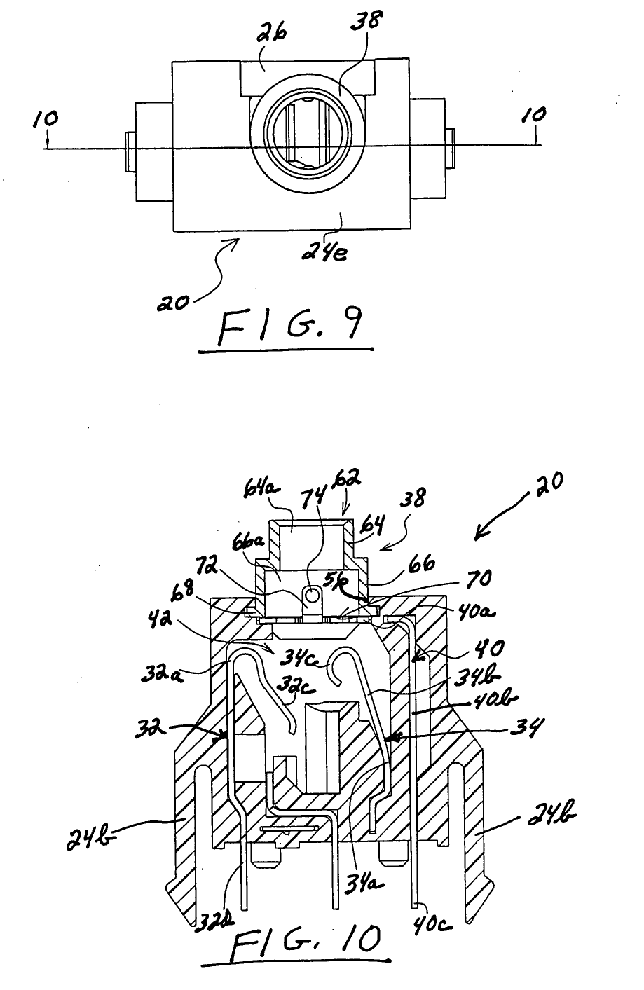

Referring to FIG. 7 in conjunction with FIG. 6, housing 24 of socket connector 20 includes a pair of mounting posts 24a and a pair of latch arms 24b for mounting the housing and, in turn, the connector on a circuit board. The housing includes a back wall 24c, a pair of side walls 24d and a top wall 24e which combine to form an interior plug-receiving cavity, generally designated 42. The housing has a plurality of mounting posts 24f for insertion into a plurality of mounting holes 26a in cover 26 for mounting the cover onto the housing and to close the interior plug-receiving cavity after the switch terminals, the signal terminals and the ground terminal are mounted in the housing, as described hereinafter.

Still referring to FIG. 7 in conjunction with FIG. 6, housing 24 includes a pair of terminal-receiving grooves 44, having narrow openings 46, for receiving switch terminals 28 and 30. A pair of terminal-receiving grooves 48, having narrow openings 50, are provided in the housing for receiving signal terminals 32 and 34. A terminal-receiving groove 52, having a narrow opening 54, is provided in the housing for receiving ground terminal portion 40. All of the narrow openings of the terminal-receiving grooves are provided in a bottom face of the housing. A plug-insertion opening 56 is formed in top wall 24e of the housing in communication with the interior plug-receiving cavity 42. A top annular groove 58 and a bottom annular groove 60 are formed in top wall 24e of the housing substantially surrounding the plug-insertion opening 56.

Referring to FIG. 8 in conjunction with FIGS. 6 and 7, switch terminal 28 has a body portion 28a, a contact portion 28b projecting upwardly from the body portion and a tail portion 28c projecting downwardly from the body portion. Switch terminal 30 has a body portion 30a, a contact portion 30b and a tail portion 30c similar to switch terminal 28. The switch terminals are mounted within the terminal-receiving grooves 44 (FIG. 7) in the housing, with tail portions 28c and 30c of the switch terminals projecting through openings 46 in the bottom face of the housing. Signal terminal 32 has a body portion 32a, a spring arm 32b bent back over the body portion and terminating in a contact portion 32c, and a tail portion 32d projecting downwardly from the body portion. Similarly, signal terminal 34 has a body portion 34a, a spring arm 34b, a contact portion 34c and a tail portion 34d. The signal terminals are mounted within the terminal-receiving grooves 48 (FIG. 7) in housing 24, with the tail portions of the signal terminals projecting downwardly through openings 50 in the bottom face of the housing.

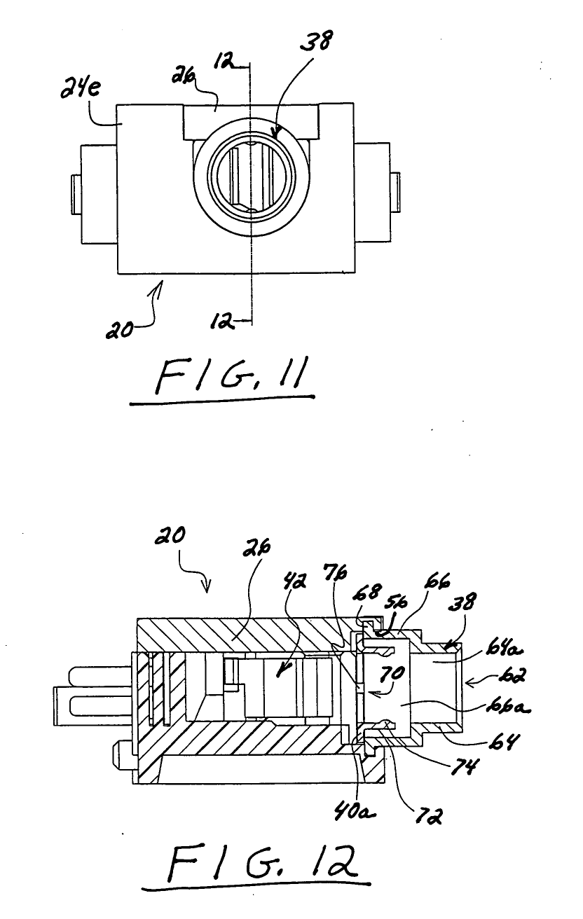

Tubular portion 38 of ground terminal 36 includes a through hole 62 which, when the tubular portion is mounted on the housing as shown in FIGS. 10 and 11, is coincident with the plug-insertion opening 56 in the top wall of housing 24. The tubular portion is fabricated of conductive metal material and includes a smaller diameter section 64 defining a small diameter section 64a of the through hole, along with a larger diameter section 66 defining a large diameter section 66a of the through hole. A circular flange 68 projects outwardly from the larger diameter section 66 at the bottom end thereof. Tubular portion 38 is mounted into housing 24 by inserting annular flange 68 into the top annular groove 58 (FIG. 7) about the plug-insertion opening 56 in the housing.

Ground terminal portion 40 of ground terminal 36 is generally L-shaped to define a mounting leg 40a, a right angled terminal leg 40b and a tail portion 40c. The ground terminal portion 40 is stamped and formed of conductive sheet metal material. A through hole 70 is formed in mounting leg 40a. The ground terminal portion is mounted in housing 24 by positioning mounting leg 40a in the bottom annular groove 60 (FIG. 7) about the plug-insertion opening 56 in top wall 24e of the housing. This can be seen clearly in FIG. 10. When so mounted, mounting leg 40a of the ground terminal portion is interengaged by a solid press-fit with the annular flange 68 of tubular portion 38. Therefore, a conductive ground runs from the tubular portion, through the ground terminal portion and to the ground trace on the circuit board.

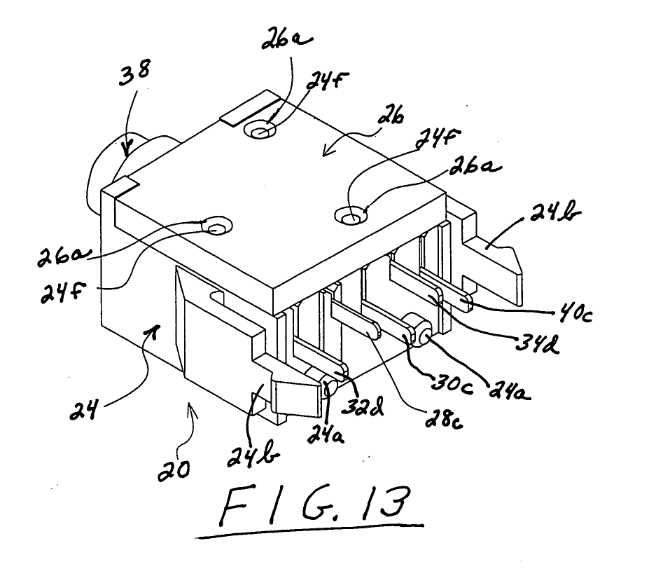

Referring to FIGS. 10 and 12 in conjunction with FIG. 6, a pair of resilient contact arms 72 are stamped and formed out of mounting leg 40a of the ground terminal portion, so that the resilient contact arms project into through hole 70 and extend generally in the insertion direction of the coaxial plug. The resilient contact arms are disposed at diametrically opposite sides of through hole 70. The contact arms have inwardly projecting contact bosses 74 to provide positive contact points for engaging the ground section of coaxial plug 22. As best seen in FIG. 6, mounting leg 40a of the ground terminal portion is generally ring-shaped, with contact arms 72 located at an inner periphery of the ring. The ring is spilt, as at 76, to further enhance the resiliency or flexibility of contact arms 72.

After switch terminals 28 and 30, signal terminals 32 and 34 and ground terminal 36, including tubular portion 38 and ground terminal portion 40, are mounted within housing 24 as shown in FIGS. 10 and 12 and as described above, cover 26 is mounted on housing 24 by inserting mounting posts 24f on the housing into mounting holes 26a of the cover. If it is desirable to provide for removal of the cover, the mounting posts simply can be press-fit into the mounting holes. Otherwise, if it is desirable to permanently mount the cover onto the housing, an appropriate adhesive, ultrasound weld or the like could be provided.

Before proceeding further, reference is made back to FIG. 8 wherein it can be seen that the coaxial or audio plug 22 includes a plug body 22a, a switch section 22b, a signal section 22c and a ground section 22d. As is known in the art, the switch section, signal section and ground section all are separated by insulators 22e.

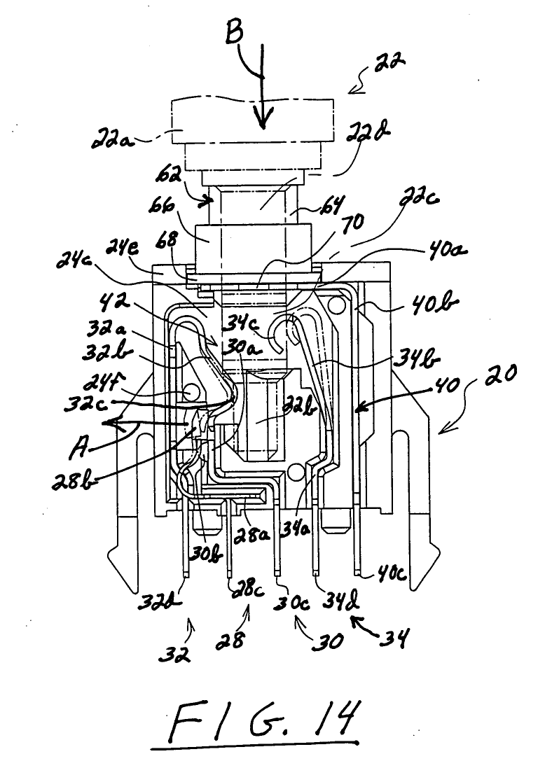

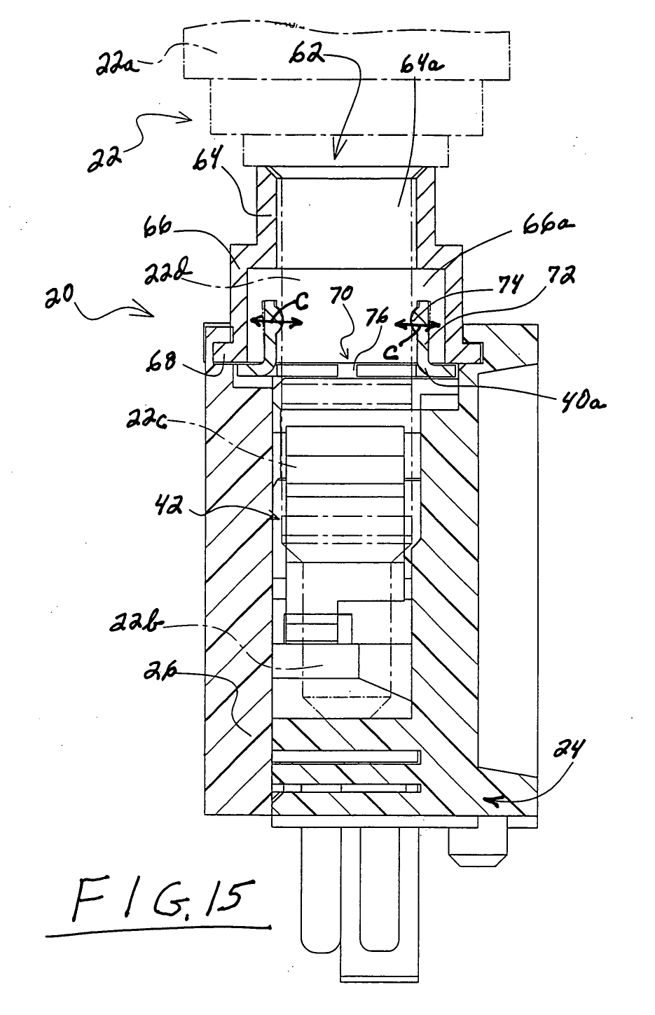

With that understanding, reference now is made to FIGS. 14 and 15 which show the sequence of operation when coaxial plug 22 is inserted into socket connector 20. When the plug is inserted, switch section 22b of the plug engages contact portion 32c of signal terminal 32 which, in turn, engages contact portion 28b of switch terminal 28 and pushes the contact portion of the switch terminal outwardly in the direction of arrow “A” (FIG. 14). This causes the two contact portions of the two switch terminals to disengage and, thereby, open the “switch” between the switch terminals. As the coaxial plug is further inserted in the direction of arrow “B”, signal section 22c of the coaxial plug engages contact portion 32c of signal terminal 32 as well as contact portion 34c of signal terminal 34 to establish a circuit from the audio plug through the signal terminals to the signal circuit traces on the circuit board. When the plug is fully inserted, ground section 22d of the coaxial plug engages the inwardly projecting contact bosses 74 on the pair of resilient contact arms 72 of the ground terminal portion of ground terminal 36 to establish a ground between the coaxial plug to the ground circuit on the circuit board. To further enhance the grounding conductivity, ground section 22d of the coaxial plug engages within the small diameter section 64 of tubular portion 38, although the primary ground connection is between the coaxial plug and the resilient contact arms 72 as seen clearly in FIG. 15. The resilient contact arms can flex in the direction of double-headed arrows “C” (FIG. 15) to maintain solid contacts with the coaxial plug.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

What is claimed is:

1. A socket connector for receiving a coaxial plug, comprising:
an insulative housing having a plug-insertion opening leading to an interior plug-receiving cavity;
at least one signal terminal mounted in the housing and including a contact portion exposed in said cavity for engaging a signal section of the coaxial plug when inserted into the cavity; and
a ground terminal mounted in the housing and including a tubular portion interengaged with a terminal portion,
said tubular portion being mounted coincident with the plug-insertion opening in the housing for receiving the coaxial plug therethrough, and
said terminal portion having a through hole aligned with the tubular portion and a pair of resilient contact arms at the through hole for engaging a ground section of the coaxial plug.

2. The socket connector of claim 1 wherein said resilient contact arms are disposed on diametrically opposite sides of the through hole in said terminal portion.

3. The socket connector of claim 1 wherein said resilient contact arms include inwardly projecting contact bosses which provide positive contact points for engaging the ground section of the coaxial plug.

4. The socket connector of claim 1 wherein said ground terminal is a two-part interengaging structure with said tubular portion and said terminal portion being separate from and independent of each other.

5. The socket connector of claim 1 wherein said terminal portion is generally L-shaped to define a mounting leg and a terminal leg extending at a right angle to the mounting leg, the mounting leg including said through hole.

6. The socket connector of claim 5 wherein said mounting leg is ring-shaped, with the contact arms located at an inner periphery of the ring.

7. The socket connector of claim 5 wherein said terminal leg includes a terminal pin at a distal end thereof for insertion into an appropriate hole in a circuit board.

8. The socket connector of claim 1 wherein said housing includes an access opening remote from said plug-insertion opening for gaining access to said interior cavity to mount the terminals therewithin.

9. The socket connector of claim 8 wherein said housing includes a cover for closing the access opening.

10. The socket connector of claim 9 wherein said housing includes a terminal-positioning groove facing said access opening for receiving the terminal portion of the ground terminal.

11. A socket connector for receiving a coaxial plug, comprising:
an insulative housing having a plug-insertion opening leading to an interior plug-receiving cavity;
at least one signal terminal mounted in the housing and including a contact portion exposed in said cavity for engaging a signal section of the coaxial plug when inserted into the cavity; and
a two-part ground terminal mounted in the housing and including a tubular portion and a separate and independent terminal portion,
said tubular portion being mounted coincident with the plug-insertion opening in the housing for receiving the coaxial plug therethrough, and
said terminal portion being generally L-shaped to define a mounting leg and a terminal leg extending at a right angle to the mounting leg, the mounting leg including a through hole aligned with the tubular portion and a pair of resilient contact arms at diametrically opposite sides of the through hole for engaging a ground section of the coaxial plug.

12. The socket connector of claim 11 wherein said resilient contact arms include inwardly projecting contact bosses which provide positive contact points for engaging the ground section of the coaxial plug.

13. The socket connector of claim 11 wherein said mounting leg is ring-shaped, with the contact arms located at an inner periphery of the ring.

14. The socket connector of claim 11 wherein said terminal leg includes a terminal pin at a distal end thereof for insertion into an appropriate hole in a circuit board.

15. The socket connector of claim 11 wherein said housing includes an access opening remote from said plug-insertion opening for gaining access to said interior cavity to mount the terminals therewithin.

16. The socket connector of claim 15 wherein said housing includes a cover for closing the access opening.

17. The socket connector of claim 16 wherein said housing includes a terminal-positioning groove facing said access opening for receiving the terminal portion of the ground terminal.

18. A socket connector for receiving a coaxial plug, comprising:
an insulative housing having a plug-insertion opening leading to an interior plug-receiving cavity;
at least one signal terminal mounted in the housing and including a contact portion exposed in said cavity for engaging a signal section of the coaxial plug when inserted into the cavity; and
a ground terminal mounted in the housing and including a through hole aligned with the plug-insertion opening in the housing, and a pair of resilient contact arms at the through hole for engaging a ground section of the coaxial plug.

19. The socket of claim 18 wherein said resilient contact arms are disposed on diametrically opposite sides of the through hole in said ground terminal.

20. The socket connector of claim 18 wherein said resilient contact arms include inwardly projecting contact bosses which provide positive contact points for engaging the ground section of the coaxial plug.

21. The socket of claim 18 wherein said ground terminal includes a generally L-shaped portion to define a mounting leg and a terminal leg extending at a right angle to the mounting leg, the mounting leg including said through hole.

22. The socket connector of claim 21 wherein said mounting leg is ring-shaped, with the contact arms located at an inner periphery of the ring.

23. The socket connector of claim 21 wherein said terminal leg includes a terminal pin at a distal end thereof for insertion into an appropriate hole in a circuit board.
